(19) United States
(12) Patent Application Publication
(10) Pub. No.: US 2009/0315686 A1
(43) Pub. Date: Dec. 24, 2009

(54) RFID TAG USING ENCRYPTED VALUE

(75) Inventor: Robert R. Oberle, Macungie, PA (US)

Correspondence Address: FLIESLER MEYER LLP, 650 CALIFORNIA STREET, 14TH FLOOR, SAN FRANCISCO, CA, 94108, US

(73) Assignee: RCD TECHNOLOGY, INC., QUAKERTOWN, PA (US)

(21) Appl. No.: 12/131,271

(22) Filed: Jun. 2, 2008

Related U.S. Application Data
(60) Provisional application No. 60/980,249, filed on Oct. 16, 2007.

(51) Int. Cl. H04Q 5/22; G06F 12/14

(52) U.S. Cl. 340/10.52; 713/193

(57) ABSTRACT

A permanent ID can be read off of an RFID chip of an RFID tag. The permanent ID can be combined with a seed value to form a combined value. The combined value can be encrypted to form an encrypted value. This encrypted value can be stored on the RFID chip. Later, the RFID tag can be validated using the encryption value.

### CLAIM OF PRIORITY

This application claims priority to U.S. Provisional Application No. 60/980,249 entitled “RFID TAG USING ENCRYPTED VALUE” by Robert R. Oberle, filed Oct. 16, 2007, which is hereby incorporated by reference [Atty. Docket No. RCDT-01022US0].

### BACKGROUND

A problem that can occur for product distribution is that of unauthorized copies of products. For example, a contract manufacture can receive the specifications for a product from a designer and make a number of authorized products. Unscrupulous manufacturers can then go on to make additional unauthorized, but identical, copies of the product to sell illegally at a high profit.

One way to get around this issue is by using a RFID tag that can encrypt and decrypt data. In this way, the integrity of products can be assured.

### SUMMARY OF THE INVENTION

The problem with using present RFID tags to secure articles is that the cost of such RFID tags for authentication can be relatively large. This is because the present state of the art is to use tags with a large block of encrypted memory to describe the article, or to utilize an off line database to store attributes of the tagged article. In the former case the protocol for decrypting the stored information are complex and often require expensive and specially configured RFID readers, in the second case maintenance and upkeep of the database as well as insuring real time access have proven to be difficult logistical tasks.

Embodiments of the present invention include ways to use the less expensive RFID tags in an encryption and authentication scheme. Encryption and decryption can be done outside the RFID tag.

Embodiments of the present invention a permanent ID that RFID chip manufacturers typically put a on the RFID chip in combination with additional data that is provided by an authenticating authority (typically the legitimate manufacturer). Since this permanent ID is added in the chip manufacture process, it is impractical to spoof. The additional data is known to the authenticating authority and may be recovered from data written to the RFID tag memory.

The permanent ID and additional data, together the authentication data, can be encrypted then the encrypted value can be stored back onto another location on the RFID chip of the RFID tag. Validation can include decryption of the encrypted value and the comparing of the decrypted value with the authentication data.

A person who wanted to spoof the RFID tag would need to have access to the encryption algorithm. Merely copying data for a previous RFID chip would not be sufficient, since when decrypted, the decrypted version of the permanent ID would not match the permanent ID placed on the RFID chip by the RFID manufacturer.

### BRIEF DESCRIPTION OF FIGURES

FIG. 1 is a flow chart illustrating an encryption method of one embodiment of the present invention.

FIG. 2 is a flow chart illustrating a decryption method of one embodiment of the present invention.

FIG. 3 illustrates an RFID chip of one embodiment of the present invention

FIGS. 4A and 4B illustrate a method of using an RFID tag of one embodiment.

FIG. 5 illustrates embodiments using decryption.

### DETAILED DESCRIPTION OF THE INVENTION

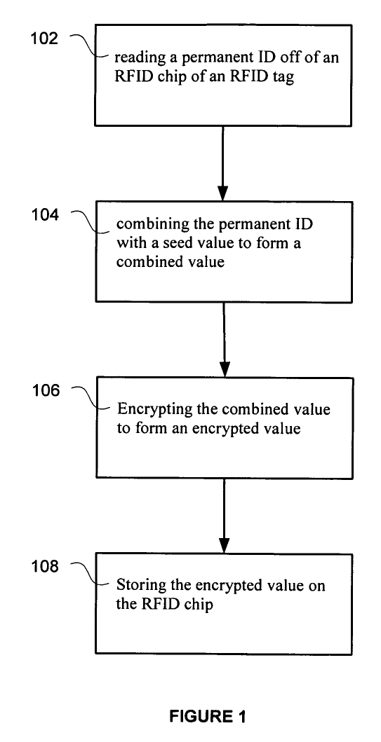

One embodiment of the present invention, as shown in FIG. 1, is a method comprising in step 102, reading a permanent ID, such as a Unique Identification (UID), off of an RFID chip of an RFID tag. In step 104, combining the permanent ID with a seed value to form a combined value. In step 106, encrypting the combined value and the seed value to form encrypted values. In step 108, storing the encrypted values on the RFID chip. The RFID tag can be authenticated using the encrypted values.

The combination can be any type of combination including the permanent value and seed value. This can include operations such as addition, subtraction and multiplication, bit shifting, Boolean operations, bit reversal, padding, truncation etc.

The RFID tag can be authenticated by decrypting the encrypted values to obtain the permanent ID and the seed value.

The derived permanent ID obtained using the encrypted value can be compared to the permanent ID off of the RFID chip. The seed value determined from the encryption value can also be validated.

The RFID chip can also include product data.

The seed value can be obtained from a pool of seed values. In one embodiment, the writing of the encrypted value to the RFID chip can be done by an RFID reader, and this RFID reader can maintain the pool of seed values.

Public/private key encryption can be used. For the purpose of following discussion, the terms public and private keys are used for convenience. The system architect may choose to publish the “private” key and keep the “public” key secret. The encrypted value can encrypted with a public key. The encrypted value can then be decrypted by a private key. Alternately, any other encryption/decryption scheme can be used.

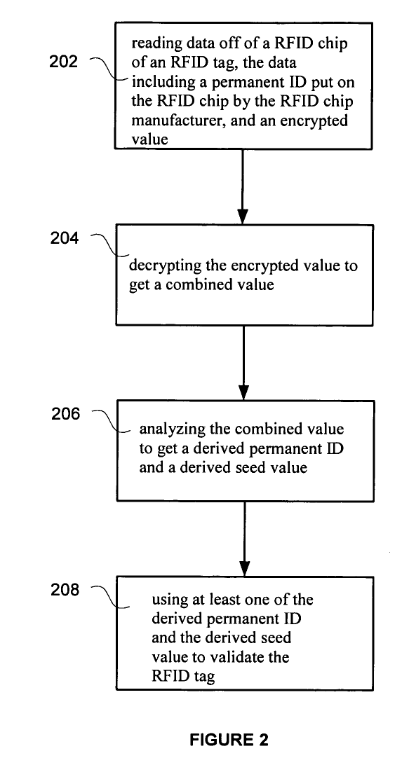

FIG. 2 is a flow chart illustrating a decryption method of one embodiment of the present invention. In step 202, data is read off of a RFID chip of an RFID tag. The data including a permanent ID put on the RFID chip by the RFID chip manufacturer, and an encrypted value.

In step 204, the encrypted value is decrypted to get a combined value. In step 206, the combined value is analyzed to get a derived permanent ID and a derived seed value.

In step 208, using at least one of the derived permanent ID and the derived seed value to validate the RFID tag. The validation can include comparing the derived permanent ID portion obtained from the encrypted value with the permanent ID put on the RFID chip by the RFID manufacturer. The validation can include analyzing the derived seed value.

In one embodiment, the seed values are encrypted. The derived seed value can be decrypted to determine if the derived seed value is valid.

The encrypted values can be encrypted with a public key and the decryption uses a private key.

The method of FIG. 2 can be done by an RFID reader.

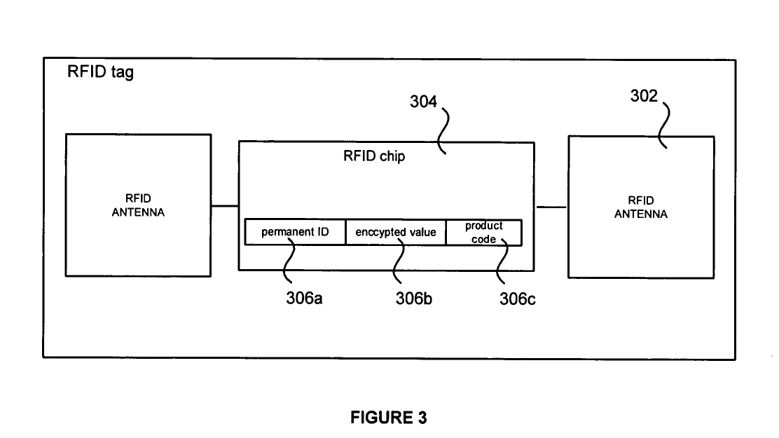

FIG. 3 shows a RFID tag comprising an RFID antenna 302 and an RFID chip 304. The RFID chip can include a permanent ID 306a put on the RFID chip 304 by the RFID chip manufacturer, and an encrypted value 306b written to the RFID chip by an RFID reader. The encrypted value 306b can be created by encrypting a combined value. The combined value can combine the permanent ID and a seed value. The RFID chip 304 can further store product data 306c.

The RFID reader 402 can be configured through software to authenticate an RFID tag through the use of a public/private key encryption method. The public key can be stored on removable media. The stored public key can be encrypted or password protected such that the user must enter data in order to access the public key. The public key can be stored locally on the reader in re-writable memory, or non-re-writable memory.

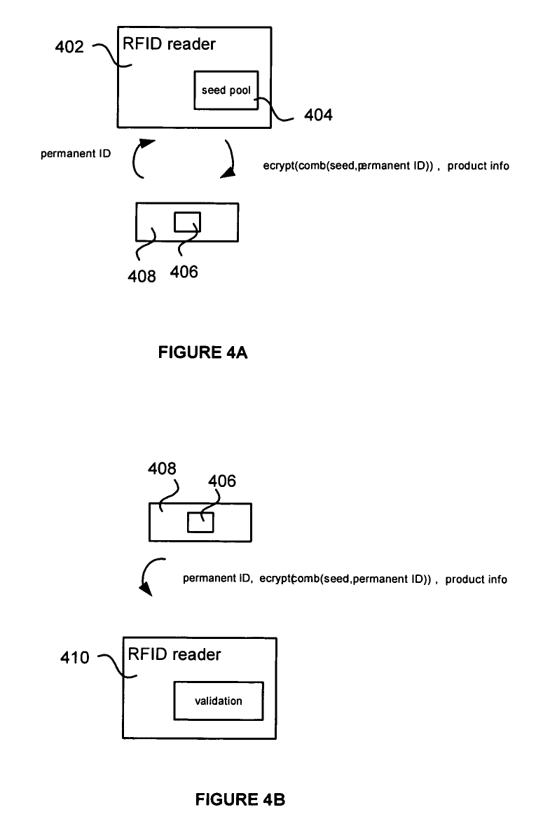

FIG. 4A shows an example of the operation of one embodiment. A RFID reader 402 can have a pool 404 of seed values. The RFID reader 404 can interrogate the RFID chip 406 and get the permanent ID. This permanent ID is combined with a seed value from the seed pool 404, and the combined value is encrypted to form an encrypted value. The encrypted value, and optionally product data, is written to the RFID chip 406 on the RFID tag 408.

Later, as shown in FIG. 4B, the RFID tag 408 can be integrated by another RFID reader 410. The seed and derived permanent ID can then be obtained and validated. The RFID reader 410 can be at a location such as US customs, a repair center or a store.

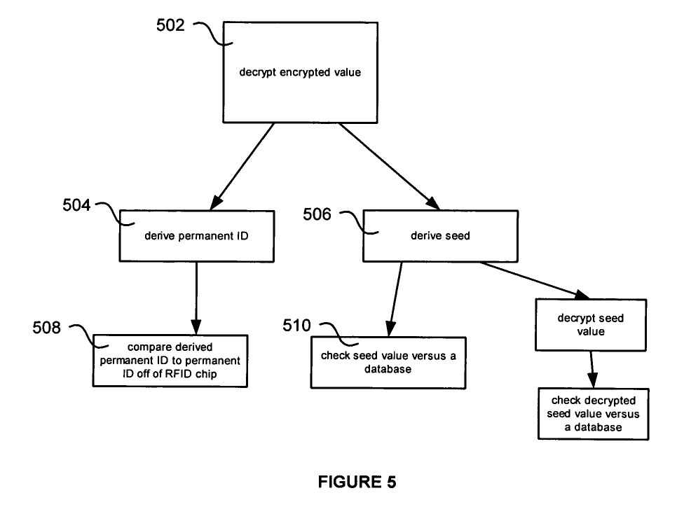

FIG. 5 shows details of validation of one embodiment. In step 502, the encryption value is used to get a derived permanent ID 504 and derived seed 506.

The derived permanent ID can be compared to the permanent ID on the chip in step 508. If a spoofed value is used, then the derived permanent ID will not match the real permanent ID.

The derived seed 506 can be checked against remote or local database. Alternately, the derived seed value can be decrypted and then compared against a remote or local database.

The present system can prevent counterfeit product from getting into the supply chain and/or detect counterfeits at any of a number inspection point inside or outside of their control. RFID tags can be used to validate if a shipment is counterfeit at a customs inspection point or other locations. A potential rogue contract manufacturer (CM) can be prevented using the technology from producing electronically verifiable fakes.

Method can be as follows:
1) A company can provide labels for the CM, potentially directly from a trusted partner, without the company ever seeing them.
2) Upon validation by the CM that an order is ready to ship, the company can provide the CM with an encrypted file with a set of seed values that correspond one to one with the number of products to be shipped. This can be done through a trusted partner.
3) RFID Reader middleware can decrypt the file and obtain the seed values.
4) The RFID Reader can obtain the permanent ID (UID) from the tag
5) The RFID Reader can perform a defined mathematical operation on the seed value and the UID of one tag (such as addition, bit shift then add, etc. . . . ). This mathematical operation can be defined by the seed value itself, i.e. add for seed numbers ending in 7, bit shift with seed numbers ending in 5 etc. . . .
6) The RFID Reader can encode the result from 5 above and the seed value using a company provided public key, and can write the resultant to defined fields in the tag memory,
7) The RFID Reader may also encode other data as desired by the designer, this may be password protected or not as desired by the designer, a date stamp can also be desirable,
8) In one embodiment, the RFID Reader validates the tag data stream but not the content,
9) Tag can be attached to the product and shipped.

At customs or other location;
a) A company provided reader with embedded middleware can use the company private key to decrypt the data from step 6 above,
b) Reader can perform the known mathematical operation from 5 above on the permanent ID (UID) and decrypted seed value, and checks to see if the results match the decrypted data,
c) If they match, the product can be validated as genuine, if not goes to quarantine.

The designer can control the private key and agreed not share it with the contract manufacturer, thus they control the validation. Potentially the trusted partner could do this as a service. Even if the contract manufacturer knows the mathematical operation the designer controls the seed values which are traceable by manufacturer.

The date stamp can be useful either as a way to shift the public/private key sets or can be combined with the seed value (mathematically) at the time of encryption. This only becomes an issue if the private key becomes compromised.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

1. A method comprising:
reading a permanent ID off of an RFID chip of an RFID tag;
combining the permanent ID with a seed value to form a combined value;
encrypting the combined value to form an encrypted value;
storing the encrypted value on the RFID chip,
wherein the RFID tag can be validated using the encryption value.

2. The method of claim 1, wherein the RFID tag can be validated by decrypting the encrypted value to obtain the permanent ID and the seed ID.

3. The method of claim 2, wherein the permanent ID derived from the encrypted value can be compared to the permanent ID off of the RFID chip.

4. The method of claim 2, wherein the seed value determined from the encryption value can be validated.

5. The method of claim 1, wherein the RFID chip also includes product data.

6. The method of claim 1, wherein the seed value is obtained from a pool of seed values.

7. The method of claim 1, wherein the method is done by an RFID reader.

8. The method of claim 1, wherein the encrypted value is encrypted with a public key.

9. An RFID tag comprising:
an RFID antenna; and
an RFID chip, the RFID chip including a permanent ID put on the RFID chip by the RFID chip manufacturer and an encrypted value, the encrypted value being created by encrypting a combined value, the combined value combining the permanent ID and a seed value.

10. The RFID tag of claim 9, wherein the seed value is obtained from a pool of seed values.

11. The RFID tag of claim 9, wherein an RFID reader obtains the permanent ID from the RFID chip, combines the permanent ID with the seed value to from a combined value, encrypts the combined value, and stores the encrypted value on the RFID chip.

12. The RFID tag of claim 9, wherein the RFID chip further stores product data.

13. A method comprising:
reading data off of a RFID chip of an RFID tag, the data including a permanent ID put on the RFID chip by the RFID chip manufacturer, and an encrypted value;
decrypting the encrypted value to get a combined value;
analyzing the combined value to get a derived permanent ID and a derived seed value; and
using at least one of the derived permanent ID and the derived seed value to validate the RFID tag.

14. The method of claim 13, wherein the validation includes comparing the derived permanent ID portion obtained from the encrypted value with the permanent ID put on the RFID chip by the RFID manufacturer.

15. The method of claim 13, wherein the validation includes analyzing the derived seed value.

16. The method of claim 15, wherein valid seed values have been encrypted and wherein the derived seed value can be decrypted to determine if the derived seed value is valid.

17. The method of claim 13, wherein the encrypted value is encrypted with a public key and the decryption uses a private key.

18. The method of claim 13, wherein the method is done by an RFID reader.

19. An RFID reader configured through software to authenticate an RFID tag through the use of a public/private key encryption method

20. An RFID reader of claim 19, wherein the public key is stored on removable media

21. An RFID reader of claim 20 wherein the stored public key is encrypted or password protected such that the user must enter data in order to access the public key.

22. An RFID reader of claim 19 wherein the public key is stored locally on the reader in re-writable memory.

23. An RFID reader of claim 22 wherein the stored public key is encrypted or password protected such that the user must enter data in order to access the public key.

24. An RFID reader of claim 19 wherein the public key is stored locally on the reader in non re-writable memory.

25. An RFID reader of claim 22 wherein the stored public key is encrypted or password protected such that the user must enter data in order to access the public key.
